(19) United States
(12) Patent Application Publication
(10) Pub. No.: US 2013/0079070 A1
(43) Pub. Date: Mar. 28, 2013

(54) CELL PHONE COVER

(71) Applicant: Ron Losiewicz, Willowbrook, IL (US)

(72) Inventor: Ron Losiewicz, Willowbrook, IL (US)

(21) Appl. No.: 13/241,593

(22) Filed: Sep. 23, 2011

(51) Int. Cl. H04M 1/00

(52) U.S. Cl. 455/575.8

(57) ABSTRACT

The present invention relates to a cell phone cover with improved dexterity and design that allows the user to secure the handling of a cell phone, specifically allowing the user to insert at least one finger underneath at least one band in the cell phone cover to secure the user's hold on the phone.

The present invention claims priority to U.S. Provisional Patent Application Ser. No. 29/376,918 filed Oct. 14, 2010, the entire disclosure of which is hereby incorporated by reference in its entirety.

### BACKGROUND

In the art of providing cell phone skins and covers, many different versions are widely available. However, many cell phone supports or covers are not configured in a manner that allows users to secure one or more fingers into the cell phone cover to prevent the cell phone from slipping out of the user's hand. In the present invention, the cell phone cover includes at least one aperture or band on the back side of the cell phone cover to allow the user to insert at least one finger in said aperture to secure the user's hold on the phone.

### SUMMARY OF THE INVENTION

An object of the present invention is to provide a cell phone cover with improved dexterity and design that allows the user to secure the handling of a cell phone. In one embodiment of the present invention, the cell phone cover includes at least one band that is attached to bottom side of the cell phone cover to allow the user to insert at least one finger underneath said band to secure the user's hold on the phone. The at least one band may be in the same plane or slightly elevated above the plane of the cell phone cover to provide the cell phone cover a sleek compact design.

The at least one band may be located on any point of the cover and in any direction of the cover. The at least one band may be located parallel to, perpendicular to or at an angle relative to the sides of the cell phone cover. The at least one band may also be of any length so long as the length does not exceed the length of the cell phone cover.

In a preferred embodiment, the at least one band is rectilinear in shape. The at least one band, however, may be of any conventional shape including but not limited to semi-circular, semi-elliptical, curved, wavy, triangular or U-shaped.

In a preferred embodiment, the at least one band includes a fastening portion that is mounted to or formed on and extends from each end of the at least one band which correlates to fastening portions on the bottom side of the cell phone cover which together are configured to operate as a fastener to releasably secure the at least one band to the bottom side of the cell phone cover. The fastening portion on the at least one band may be comprised of a T-shaped element that corresponds to slots or slits on the bottom side of the cover to removably secure the at least one band in place. In one embodiment, the fastening portions may be a complementary hook and loop fastener material, such as Velcro. The fastening portion may be comprised of any conventional fastening means including protruding rectilinear element, hook, latch, magnet, prong, clip, wedge, cam, grooved rectilinear element, or recessed rectilinear element.

In one embodiment, the least one band may be permanently fixed to the bottom side of the bottom side of the cell phone cover.

In another embodiment of the present invention, the at least one band may be a continuous loop. In this embodiment, the cell phone cover has slits or slots into which the continuous loop enters such that the at least one band has one top portion that is visible from a bottom view of the cell phone cover and one hidden portion that is not visible from such view.

In another embodiment, the at least one band may be formed by at least two cut outs or slits in the cell phone cover body to provide at least one slit on each side of a thin strip of material.

In another embodiment of the present invention, the cell phone cover may include a swivel mount that is permanently fixed to the bottom side of the cell phone cover. In this embodiment, the at least one band is fastened to the top of the swivel mount to allow the at least one band to rotate and provide the user the ability to hold the cell phone securely at different rotations. With the inclusion of a swivel mount, the at least one band is then rotatably attached to the cell phone cover and therefore adjustably positionable to any one of a plurality of stable positions. In an alternate embodiment, the cell phone cover may include a swivel clip that is permanently fixed to the bottom side of the cell phone cover. In this embodiment, the at least one band is fastened to the top of the swivel clip.

### BRIEF DESCRIPTION OF DRAWING

FIG. 1 is a bottom view of an embodiment for a design for an improved cell phone cover;

FIG. 2 is a perspective bottom view of an embodiment;

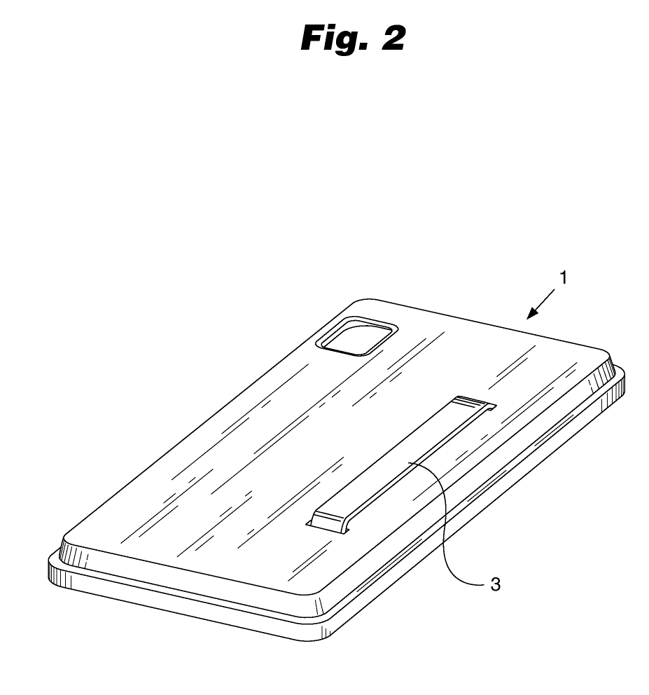

FIG. 3 is a top view of an embodiment;

FIG. 4 is a side view of an embodiment;

FIG. 5 is a bottom view of another embodiment for a design for an improved cell phone cover wherein the at least one band is located at an angle relative to the side of the cell phone cover body;

FIG. 6 is a perspective bottom view of the an embodiment of the present invention wherein the at least one band is located at an angle relative to the side of the cell phone cover body;

FIG. 7 is a top view of an embodiment of the present invention wherein the at least one band is located at an angle relative to the side of the cell phone cover body;

FIG. 8 is a side view of an embodiment wherein the at least one band is located at an angle relative to the side of the cell phone cover body;

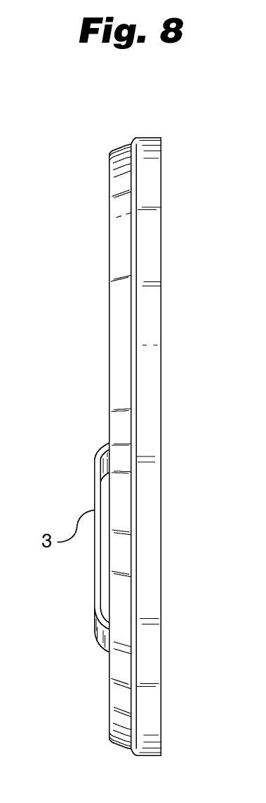

FIG. 9 is a bottom view of another embodiment of the present invention where in the at least one bad is a continuous loop.

FIG. 10 is a perspective view of another embodiment of the present invention wherein the cell phone cover has at least two slit or cutout;

FIG. 11 is a bottom view of an embodiment of the present invention wherein the cell phone cover has at least two slit or cutout; and

FIG. 12 is a top view of another embodiment of the present invention wherein the cell phone cover has at least two slit or cutout;

### DETAILED DESCRIPTION

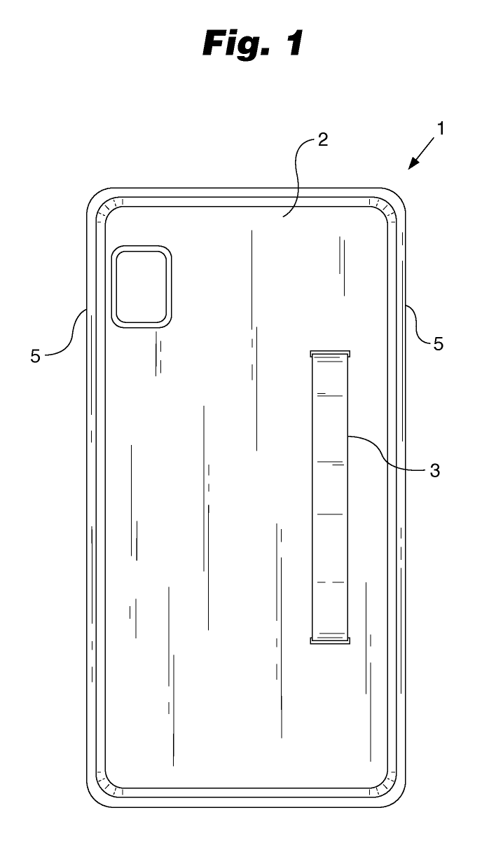

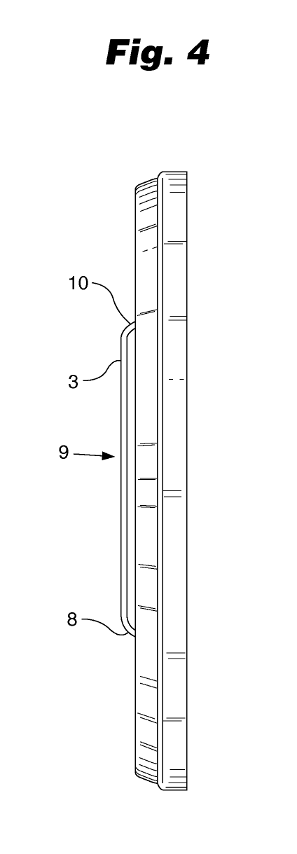

As shown in FIG. 1, the cell phone cover of the present invention is comprised of a cell phone cover body (shown general at 1) dimensioned to accept the bottom surface and side surface of a cell phone and at least one band 3 that is attached to the bottom side 2 of the cell phone cover body 1 to allow the user to insert at least one finger underneath said at least one band 3 to secure the user's hold on the phone. In this embodiment, the at least one band 3 is located parallel to the two longer sides 5 of the cell phone cover and rectilinear in shape. In this embodiment, as shown in FIG. 4, the center point 9 of the at least one band 3 is located directly below the plane of the cell phone cover body to provide a compact sleek design. In a preferred embodiment, the center point 9 of the at least one band 3, will be a maximum height from the surface of the cell phone cover body such that there will be no space or a minimum space between the plane of the cellphone cover body 1 and the plane of the at least one band 3. to provide a sleek design but allows the user to fit at least one finger underneath such band. In a preferred embodiment, the at least one band 3 is made of an elastomeric material to allow the at least one band 3 to stretch when the user places a finger under said at least one band and return to its original position when the user removes his or her finger from beneath the at least one band 3.

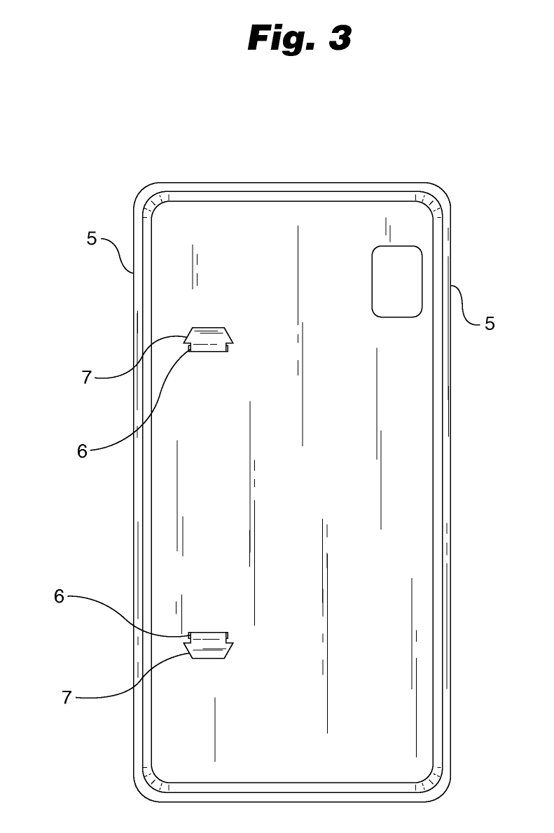

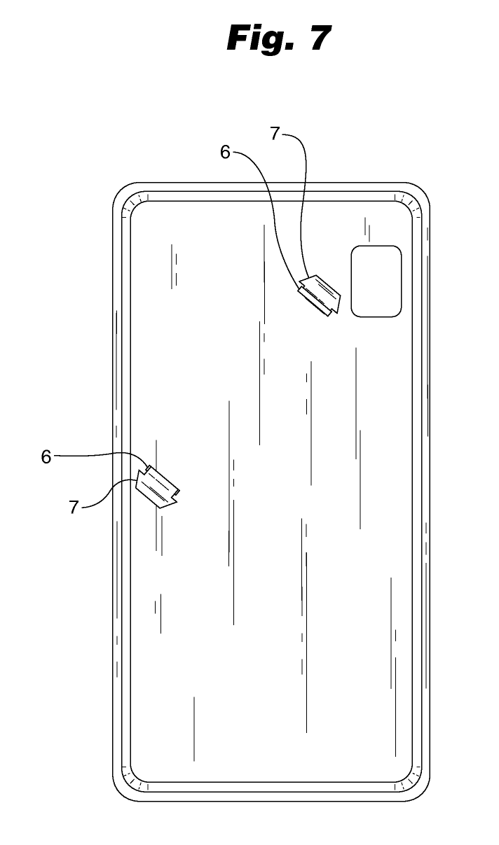

As shown in FIGS. 3 and 4, the cell phone cover body 1 may have at least two slots 6 into which each end 8 and 10 of the at least one band 3 is fastened. The at least one band 3 is fastened to the cell phone cover body 1 through fastening tabs 7 which are shown in FIGS. 3 and 7. At least one fastening tab 7 is formed or affixed to each end of the at least one band 8, 10. The at least one fastening tab 7 is pushed through at least one slot 6 of the cell phone cover body 1 to lock the at least one fastening tab 7 into place. The at least one fastening tab 7 may be trapezoidal in shape and larger in width relative to the body of the at least one band 3 and the corresponding slits or slots 6 in the cell phone cover body 1 to secure the at least one band 3 in place. The fastening tab may be any conventional shape including but not limited to T-shaped, rectilinear, circular, semicircular, polygonal, and trapezoidal. Although a fastening tab is illustrated in FIG. 3, the fastening portion on the at least one band may be comprised of a T-shaped element that corresponds to slots or slits on the bottom side of the cover to removably secure the at least one band in place. In one embodiment, the fastening portions may be a complementary hook and loop fastener material, such as Velcro. The fastening portion may be comprised of any conventional fastening means including protruding rectilinear element, hook, latch, magnet, prong, clip, wedge, cam, grooved rectilinear element, or recessed rectilinear element.

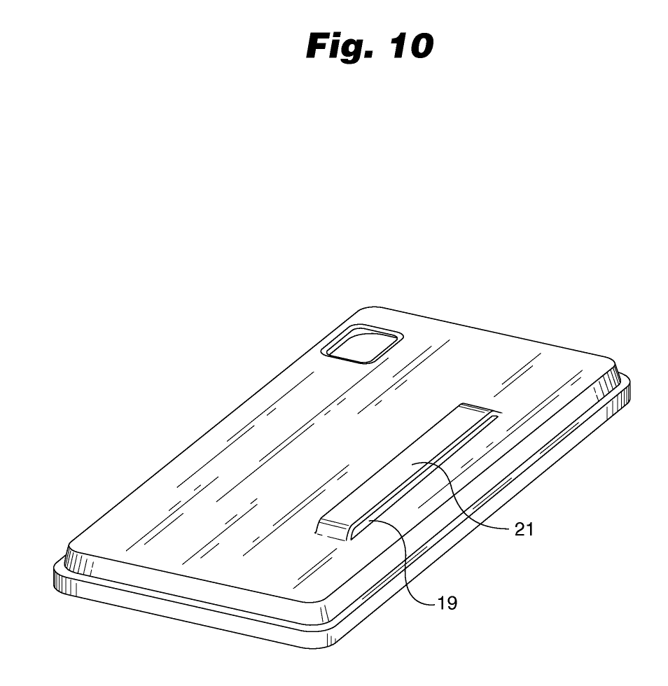

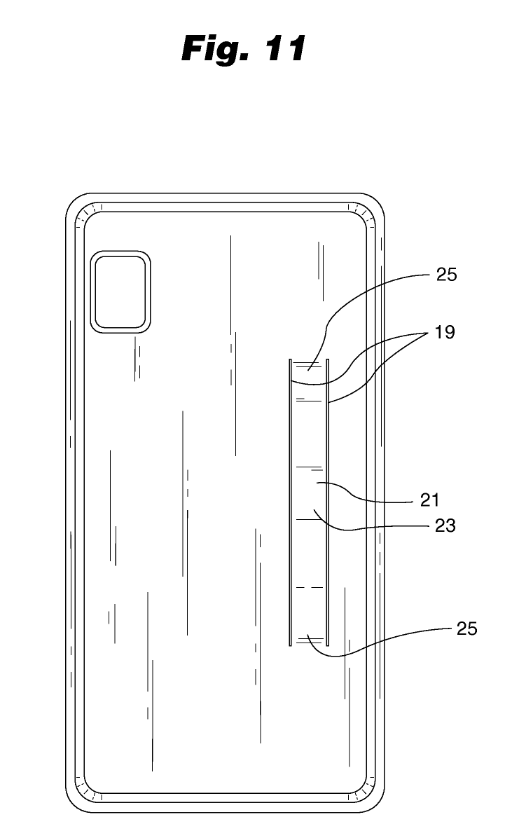

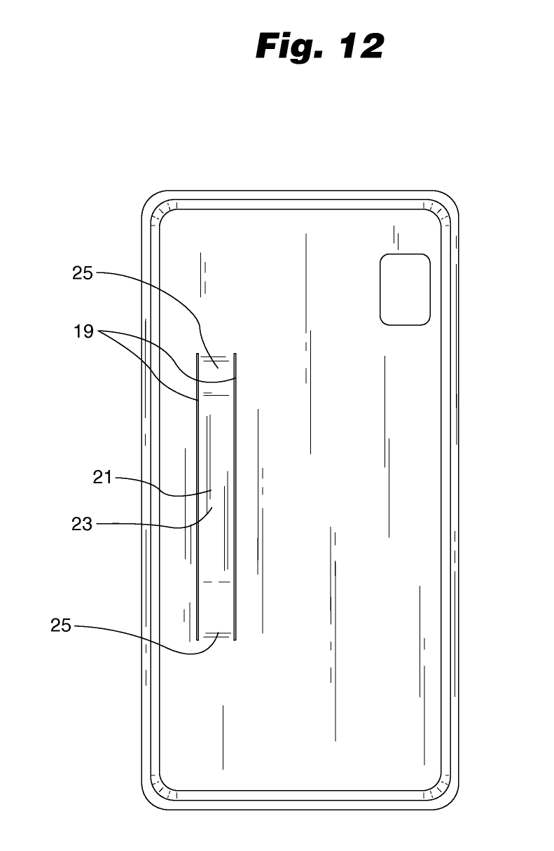

In another embodiment, as shown in FIGS. 10, 11, and 12, the at least one band may be formed by at least two cut outs or slits 19 in the cell phone cover body 1 to provide at least one slit 19 on each side of a thin strip of material 21. In the present embodiment, as shown in FIGS. 11 and 12, the center point 23 of the at least one band or strip 21 is in the same plane of the cell phone cover body 1. The benefit of this embodiment is the ease of manufacturing and lowered costs production since the at least two cut outs or slits 19 may be performed during the manufacture of the cell phone cover body 1. In a preferred embodiment, the at least one band or strip 21 may be reinforced by having the at least one band or strip 21 and each end of the at least one band 25 be of a greater thickness to prevent the at least one band or strip 21 from being tearing during extensive wear and tear.

The benefit of the present invention over conventional cell phone covers is that it allows a user to securely hold a cell phone while holding the phone up to the user's face. The present invention is both easy to manufacture and likewise easy to use.

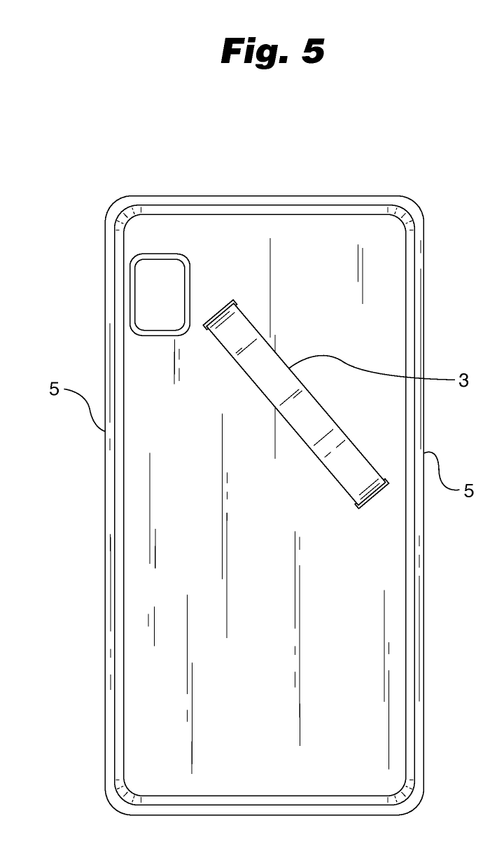

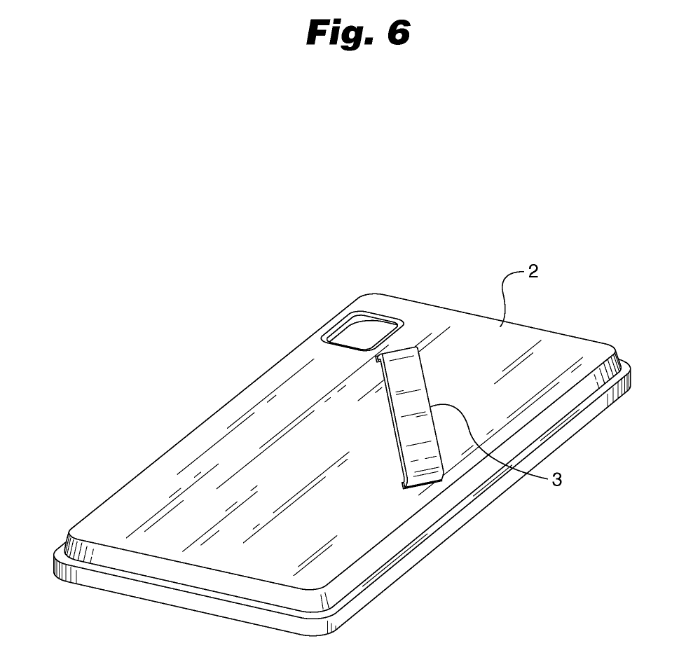

As shown in FIGS. 5 and 6, the at least one band 3 may be located at an angle relative to the sides 5 of the cell phone cover. The band may be located at any point on the cell phone cover body and may be located at any angle relative to the sides of the cell phone cover.

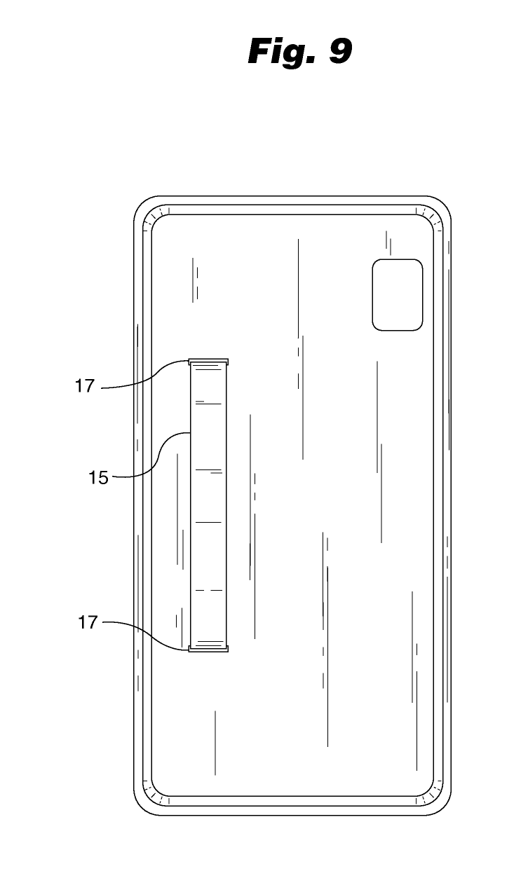

In another embodiment, as shown in FIG. 9, the at least one band 3 may be comprised of a single continuous loop 15 that is secured in place through at least two slits 17 in the cell phone cover body 1. The at least one band is one loop that passes through at least two slots 17 in the cell phone cover body 1.

In another embodiment of the present invention, the cell phone cover may include a swivel mount (not shown) that is permanently fixed to the bottom side of the cell phone cover. In this embodiment, the at least one band is fastened to the top of the swivel mount to allow the at least one band to rotate and provide the user the ability to hold the cell phone securely at different rotations. With the inclusion of a swivel mount, the at least one band is then rotatably attached to the cell phone cover and therefore adjustably positionable to any one of a plurality of stable positions. In an alternate embodiment, the cell phone cover may include a swivel clip that is permanently fixed to the bottom side of the cell phone cover. In this embodiment, the at least one band is fastened to the top of the swivel clip.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I hereby claim:

1. An improved cover for a cell phone, comprising
A body dimensioned to accept the bottom surface and side surfaces or a cell phone; and
At least one band that is fastened to the body to allow the user to insert at least one finger underneath said band to secure the user's hold on the phone.

2. An improved cover according to claim 1, wherein the at least one band is fastened to the body with fastener tabs.

3. An improved cover according to claim 2, wherein the body has at least two slots

4. An improved cover according to claim 1, wherein the at least one band is parallel to the sides of the body.

5. An improved cover according to claim 1, wherein the at least one band is at between 1 and 90 degrees relative to the sides of the body.

6. An improved cover for a cell phone, comprising
A body dimensioned to accept the bottom surface and side surfaces or a cell phone; and
At least one continuous loop that is secured to the body to allow the user to insert at least one finger through said loop to secure the user's hold on the phone.

7. An improved cover according to claim 6, wherein the body has at least two slots

8. An improved cover according to claim 6, wherein the at least one continuous loop is located parallel to the sides of the body.

9. An improved cover according to claim 6, wherein the at least one continuous loop is located between 1 and 90 degrees relative to the sides of the body.

10. An improved cover for a cell phone, comprising
A body dimensioned to accept the bottom surface and side surfaces or a cell phone, the body having at least two slits to form at least one strip allowing the user to insert at least one finger underneath said strip to secure the user's hold on the phone.

11. An improved cover according to claim 10, wherein the at least one strip is parallel to the sides of the body.

12. An improved cover according to claim 10, wherein the at least one strip is at between 1 and 90 degrees relative to the sides of the body.

13. An improved cover according to claim 10, wherein the body has at least two cut outs forming at least one strip.

14. An improved cover according to claim 10, wherein the at least one strip is located parallel to the sides of the body.

15. An improved cover according to claim 10, wherein the at least one strip is located between 1 and 90 degrees relative to the sides of the body.
